(19) United States
(12) Patent Application Publication
(10) Pub. No.: US 2005/0259858 A1
(43) Pub. Date: Nov. 24, 2005

(54) Money checking apparatus

(75) Inventors: Sheng-Pin Su, Chung Li City (TW); Chun-Kun Yu, Tao Yuan City (TW); Daniel Jih Huah Wu, Chung Li City (TW)

Correspondence Address: TROXELL LAW OFFICE PLLC, SUITE 1404, 5205 LEESBURG PIKE, FALLS CHURCH, VA, 22041, US

(73) Assignee: EINS OE-TECH CO., LTD.

(21) Appl. No.: 10/851,109

(22) Filed: May 24, 2004

(51) Int. Cl. G06K 9/00

(52) U.S. Cl. 382/135

(57) ABSTRACT

A money checking apparatus has a U-shaped with having a cavity with a receiving space for receiving an object to be tested, an LCD monitor arranged atop the cavity for viewing a status of the object, and a first switch and a second switch being placed beside the receiving space and operated to turn on/off at least one infrared lamp and ultraviolet lamp. A CMOS sensor is arranged on an inner face beside the cavity and connected to the second switch and the LCD monitor, the CMOS sensor fetching the image reflected from the optical object and displaying the image on the LCD monitor. A processor is arranged in the base and connected to a power supply, the receiver, the first switch and the second switch. The money checking apparatus can be used to examine US dollars, euro bills, Chinese RMB bills and credit cards.

### FIELD OF THE INVENTION

The present invention relates to a money checking apparatus, especially to a money checking apparatus using CMOS sensor and LCD unit to detect counterfeits of, for example, US, euro and RMB bills.

### BACKGROUND OF THE INVENTION

The prior art money checking apparatus generally receives a bill by a roller and scan the bill along the longitudinal axis of the bill with a magnetic reader. The magnetic reader reads a mark and magnetic ink on the bill and compares the reading result with a predetermined reference value to detect counterfeit money.

However, the magnetic reader may be tainted by a drop of ink from the bill. Moreover, the magnetic reader may be cheated by a counterfeit bill made with a copier equipped with magnetic ink.

Therefore, an optical money checking apparatus is developed to overcome above drawback. The optical money checking apparatus detects an entrance of a bill by optical interrupter and triggers a roller to receive the bill to be tested. The optical money checking apparatus comprises an infrared LED, a visible-light LED and a photo detector for detecting a reflection ratio, a transmitting ratio and a phosphor coating on various portions of the bill. Therefore, the denomination, security band and color of the bill can be identified.

Moreover, the prior art money checking apparatus generally comprises a CCD (charge coupled device) sensor to detect the image of the bill under test and displays the image on a CRT monitor.

However, the CRT monitor is large and bulky and the CCD sensor is expensive, which inconveniences a user.

Moreover, the existing money checking apparatus lacks the ability to detect simultaneously counterfeits of, for example, US dollar, euro and Chinese RMB bills.

### SUMMARY OF THE INVENTION

It is an object of the present invention to provide a cheaper money checking apparatus, in which a CMOS sensor is used to reduce power consumption and enhance the S/N ratio.

It is another object of the present invention to provide a smaller money checking apparatus by using an LCD monitor to replace the conventional CRT monitor.

It is still another object of the present invention to provide a money checking apparatus with the ability to discriminate counterfeits of, for example, US dollar, euro and Chinese RMB bills.

To achieve the above objects, the present invention provides a money checking apparatus comprising elements as follows. A base has a cavity with a receiving space formed therein. An object to be tested is placed in the receiving space, an LCD monitor is arranged atop the cavity for viewing a status of the object to be tested, a first switch and a second switch are located beside the receiving space and used to turn on/off at least one infrared lamp and ultraviolet lamp. A power supply is arranged within the base and connected to an emitter to convert DC power into working power. An optical object is placed on top of the cavity to reflect an image of the object to be tested. A CMOS sensor is arranged on an inner face beside the cavity and connected to the second switch and the LCD monitor. The CMOS sensor fetches the image reflected from the optical object and displays the image on the LCD monitor. A processor is arranged in the base and connected to the power supply, the receiver, the first switch and the second switch. When the processor receives an indication that the receiver is not receiving the infrared signal from the emitter, the processor supplies power to the ultraviolet lamp, the infrared lamp, the CMOS sensor and the LCD monitor by operating the first switch and the second switch.

The base preferably is U-shaped.

The object to be tested is a US dollar bill, a euro bill or a Chinese RMB bill.

The LCD monitor can be replaced by CRT monitor.

The emitter is at the top of the cavity.

The ultraviolet lamp is at the top of the cavity.

The infrared lamp is at the top of the cavity.

### BRIEF DESCRIPTION OF DRAWING

The foregoing aspects and many of the attendant advantages of this invention will be more readily appreciated as the same becomes better understood by reference to the following detailed description, when taken in conjunction with the accompanying drawings, wherein:

FIG. 1 shows a perspective view of the present invention;

FIG. 2 shows a cross-sectional view of the present invention;

FIG. 3 shows a block diagram of the present invention;

FIG. 4 shows a circuit diagram of the present invention;

FIG. 5 shows another circuit diagram of the present invention; and

FIG. 6 shows the operation of the present invention.

### DETAILED DESCRIPTION OF THE INVENTION

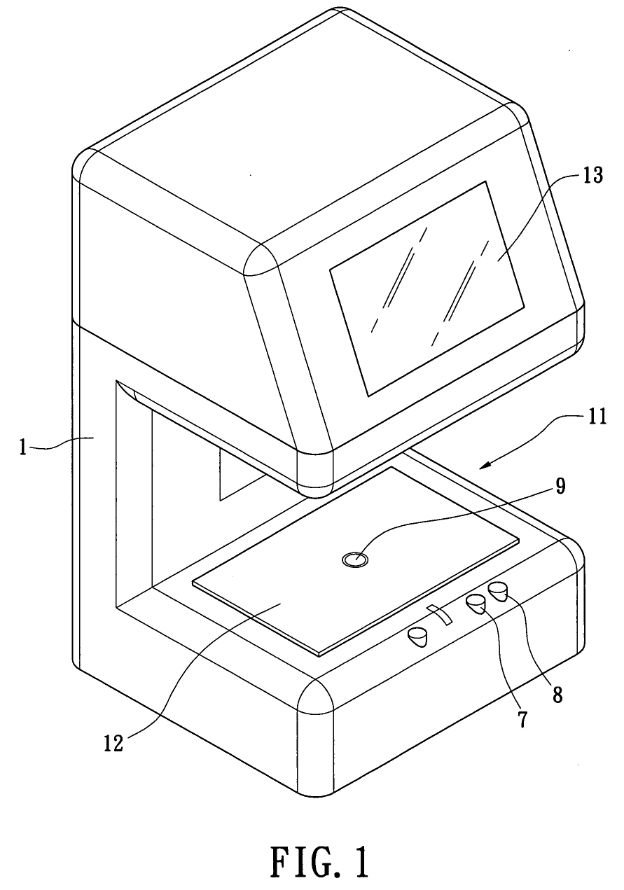

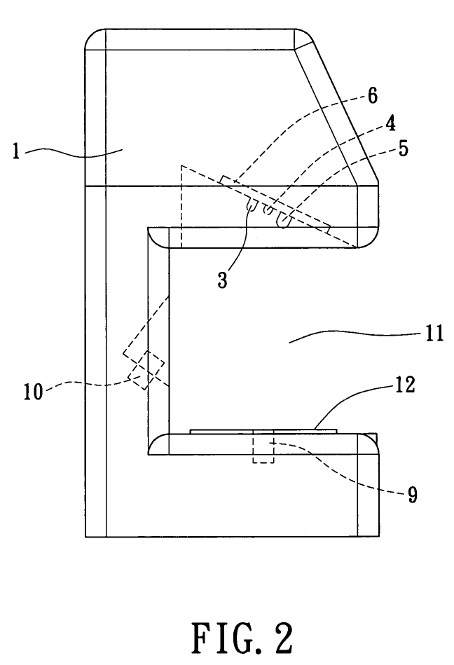

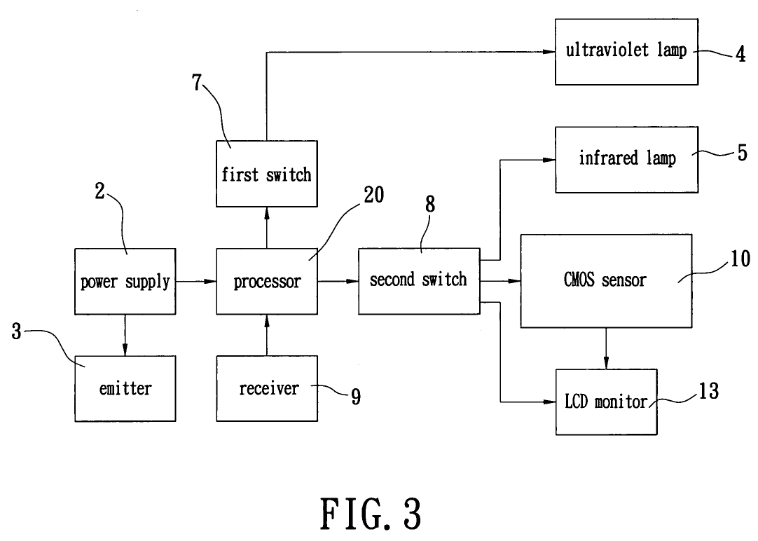

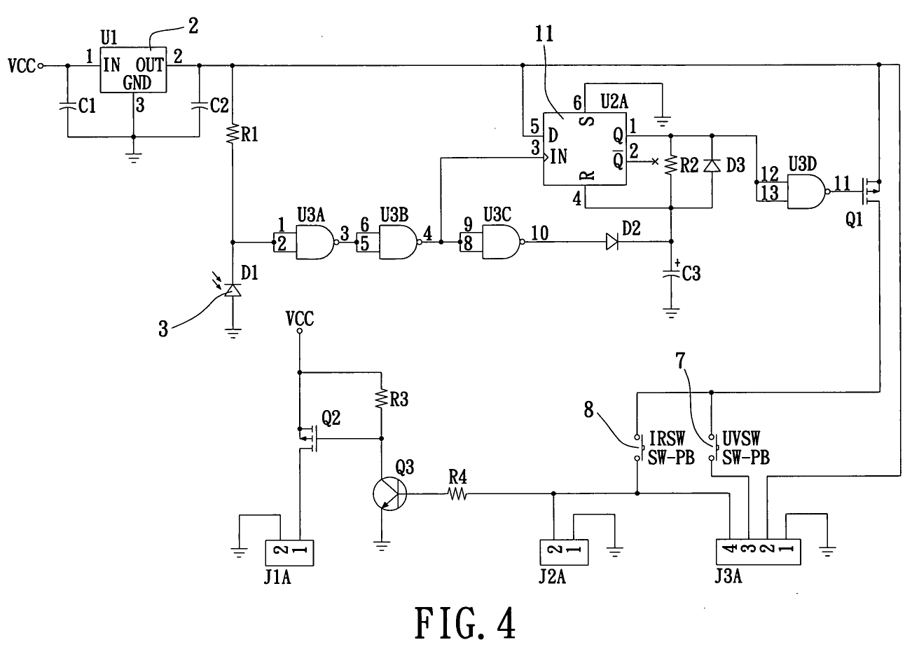

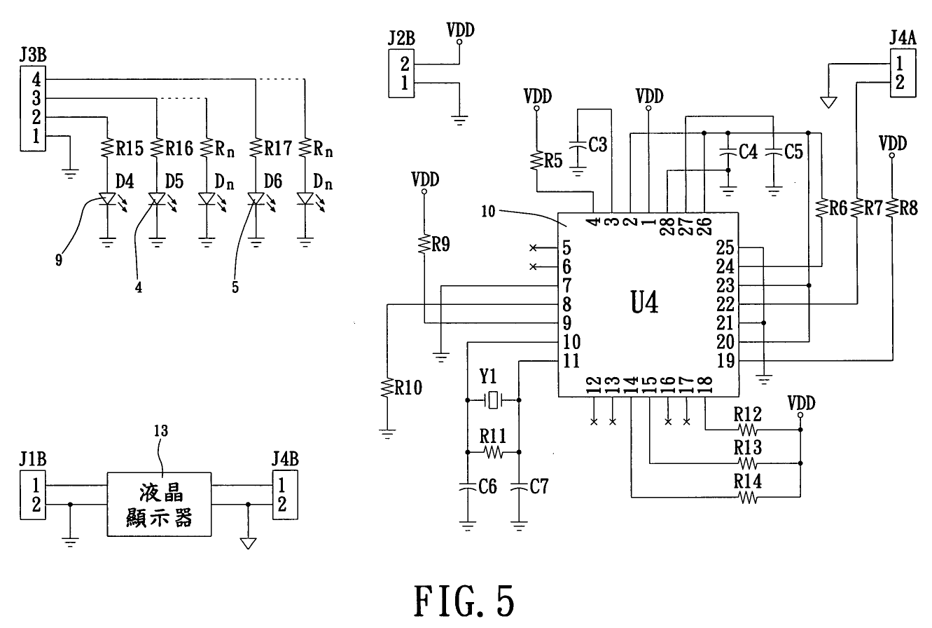

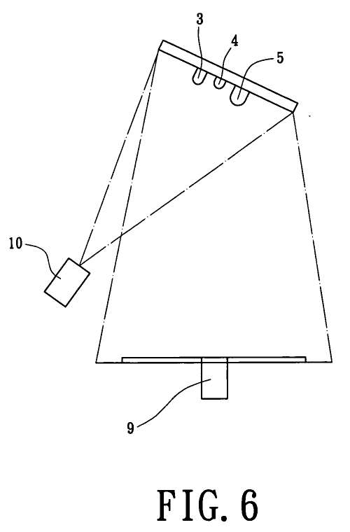

With reference to FIGS. 1 to 6, the present invention to provide a money checking apparatus with the ability to detect counterfeit money, including US dollar, euro and Chinese RMB bills. The money checking apparatus according to the present invention comprises a base 1, a power supply 2, an emitter 3, an ultraviolet light lamp 4, an infrared lamp 5, an optical unit 6, a first switch 7, a second switch 8, a receiver 9, a CMOS sensor 10 and a processor 20.

The base 1 is U-shaped with a hollow cavity 11 and a receiving space 12 for accommodating the object under test (such as money or a credit card). An LCD monitor 13 is placed atop the cavity 11 to display the status of the object under test (for example, the denomination or icon of a bill).

The power supply 2 comprises a power-stabilizing IC U1, capacitors C1 and C2 and is arranged in the base 1 to convert an input DC power to a working power for other portions of the money checking apparatus.

The emitter 3 is an infrared LED D4 arranged on top of the cavity 11 and connected to the output end of the power supply 2 to emit an infrared signal.

The ultraviolet lamp 4 (UV lamp D5) is also arranged on top of the cavity 11 to illuminate the object under test (such as money or a credit card).

The optical unit 6 (such as a mirror) is arranged on top of the cavity 11 to reflect an image of the object under test (such as money or a credit card).

The first switch 7 is arranged on a bottom of the cavity 11 and beside the receiving space 12 to turn on/off the ultraviolet light lamp 4.

The second switch 8 is arranged on a bottom of the cavity 11 and beside the receiving space 12 to turn on/off the infrared lamp 5.

The receiver 9 is a photo diode D1 arranged in the middle of the receiving space 12 and receives the infrared signal from the emitter 3 when the object under test is not present in the receiving space 12.

The CMOS sensor 10 comprises IC U4, crystal Y1, capacitors C3-C7, and resistors R5-R14 and is arranged on an inner face beside the cavity 11. The CMOS sensor 10 is connected to the second switch 8 and the LCD monitor 13 to fetch the image reflected from the optical unit 6 and display the same on the LCD monitor 13.

The processor 20 comprises IC U2A, U3A-U3D and transistor Q3 and is arranged in the base 1. The processor 20 is connected to the power supply 2, the receiver 9, the first switch 7 and the second switch 8.

The processor 20 receives an indication of the receiver 9 that the receiver 9 does not receive the infrared signal from the emitter 3 and supply power to the ultraviolet light lamp 4, the infrared lamp 5, the CMOS sensor 10 and the LCD monitor 13 through operating the first switch 7 and the second switch 8.

When the money checking apparatus is in stand-by status, the emitter 3 keeps illuminating the receiving space 12. When the object under test is present in the receiving space 12, the receiver 9 senses the presence of the object and sends a signal indicating the presence of the object to the processor 20. Therefore, the processor 20 supplies power to the ultraviolet light lamp 4, the infrared lamp 5, the CMOS sensor 10 and the LCD monitor 13 through operating the first switch 7 and the second switch 8. At the same time, the CMOS sensor 10 fetches an image reflected from the optical unit 6 and displays the image on the LCD monitor 13. Therefore, the user can view the image of the object under test on the LCD monitor 13. The money checking apparatus returns to the stand-by status when the object is removed from the receiving space 12.

Moreover, the LCD monitor 13 can be replaced by a CRT monitor.

To sum up, the money checking apparatus according to the present invention can reduce power consumption and enhance the S/N ratio, has a reduced size by using LCD monitor to replace conventional CRT monitor and has the ability to detect counterfeits of, for example, US dollar, euro and Chinese RMB bills.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A money checking apparatus, comprising:
a base having a cavity with a receiving space formed therein, an object to be tested being placed in the receiving space, an LCD monitor being arranged atop the cavity for viewing a status of the object to be tested, a first switch and a second switch being placed beside the receiving space and being operated to turn on/off at least one infrared lamp and an ultraviolet lamp;
a power supply arranged within the base and connected to an emitter to convert DC power into working power;
an optical object placed on top of the cavity to reflect an image of the object to be tested;
a CMOS sensor arranged on an inner face beside the cavity and connected to the second switch and the LCD monitor, the CMOS sensor fetching the image reflected from the optical object and displaying the image on the LCD monitor; and
a processor arranged in the base and connected to the power supply, the receive, the first switch and the second switch;
wherein when the processor receives an indication that receiver is not receiving the infrared signal from the emitter, the processor supplies power to the ultraviolet lamp, the infrared lamp, the CMOS sensor and the LCD monitor through operating the first switch and the second switch.

2. The money checking apparatus as in claim 1, wherein the base is U-shaped.

3. The money checking apparatus as in claim 1, wherein the object under test is a US dollar bill, a euro bill, a Chinese RMB bill or a credit card.

4. The money checking apparatus as in claim 1, wherein the LCD monitor is replaced by a CRT monitor.

5. The money checking apparatus as in claim 1, wherein the emitter is an infrared diode.

6. The money checking apparatus as in claim 5, wherein the emitter is at a top of the cavity.

7. The money checking apparatus as in claim 1, wherein the optical object is a mirror.

8. The money checking apparatus as in claim 1, wherein the ultraviolet lamp is at a top of the cavity.

9. The money checking apparatus as in claim 1, wherein the infrared lamp is at a top of the cavity.
